(19) United States
(12) Patent Application Publication
(10) Pub. No.: US 2018/0191529 A1
(43) Pub. Date: Jul. 5, 2018

(54) SIGNAL DECISION DEVICE AND SIGNAL DECISION METHOD

(71) Applicant: AMLOGIC (SHANGHAI) CO., LTD., Shanghai (CN)

(72) Inventors: Jin NIU, Shanghai (CN); Xiaotong LIU, Shanghai (CN); Jinhong ZHANG, Shanghai (CN); Chun WANG, Shanghai (CN)

(21) Appl. No.: 15/560,030

(22) PCT Filed: Apr. 18, 2017
(86) PCT No.: PCT/CN2017/080934

§ 371 Date: Sep. 20, 2017

(30) Foreign Application Priority Data
Jun. 15, 2016 (CN) 201610423404.0

(51) Int. Cl. H04L 25/03; H04L 27/18

(52) U.S. Cl. CPC H04L 25/03019; H04L 27/18; H04L 25/03312

(57) ABSTRACT

The invention relates to the field of equalizer technology, more specifically, to a signal decision device and a signal decision method. By calculating an error for the hard decision signal, and then implementing a condition decision via the threshold condition, the invention decides to output the equalization time domain signal or the hard decision signal, and reduces the error of the output signal. The above technical solution improves the performance of the equalizer by implementing the iteratively update directly via soft bit information instead of the hard decision signal.

### CROSS-REFERENCE TO RELATED APPLICATIONS

The present application claims priority to and the benefit of Chinese Patent Application No. CN 201610423404.0, filed on Jun. 15, 2016, the entire content of which is incorporated herein by reference.

### BACKGROUND OF THE INVENTION

### 1. Field of the Invention

The invention relates to the field of equalizer technology, more specifically, to a signal decision device and a signal decision method.

### 2. Description of the Related Art

In the current equalizer, the time domain signal after being equalized (equalized time domain signal) is usually decided by the hard decision method to further iteratively update the time domain signal. However, only using the method of hard decision may cause a great error in the time domain signal, so as to affect the performance of equalizer.

### SUMMARY OF THE INVENTION

For the deficiencies of the prior art, the invention provides a signal decision device and a signal decision method.

The technical solution is as follows.

A signal decision device comprising:

a signal source, configured to provide an equalized time domain signal;

a hard decision device, connected to the signal source, and configured to implement a hard decision on the equalized time domain signal so as to output a hard decision signal and the equalized time domain signal;

an error calculator, connected to the hard decision device, and configured to output an error signal according to the hard decision signal and the equalized time domain signal;

a condition decision device, connected to the error calculator and the hard decision device respectively, and configured to acquire the equalized time domain signal, the hard decision signal and the error signal, and to implement a condition decision on the equalized time domain signal and the error signal through a pre-stored threshold condition, so as to output the hard decision signal or the equalized time domain signal.

Preferably, the equalized time domain signal includes an in-phase signal and a quadrature signal, and the hard decision device outputs a hard decision in-phase signal after implementing a hard decision on the in-phase signal, and a hard decision quadrature signal after implementing a hard decision on the quadrature signal.

Preferably, the hard decision device simultaneously implements a hard decision on the in-phase signal and the quadrature signal, so as to output the hard decision in-phase signal and the hard decision quadrature signal.

Preferably, the error signal is a difference value between the hard decision signal and the equalized time domain signal.

Preferably, the error calculator is further configured to calculate the difference value between the hard decision in-phase signal and the in-phase signal, and the difference value between the hard decision quadrature signal and the quadrature signal, respectively.

A signal decision device comprising:

a signal source, configured to provide an equalized time domain signal,

a hard decision device, comprising a decision signal input terminal and a decision result output terminal, wherein the decision signal input terminal inputs the equalized time domain signal, and the decision result output terminal outputs a hard decision signal,

a condition decision device, comprising a first signal input terminal, a second signal input terminal, a control signal input terminal and a signal output terminal, wherein the first signal input terminal inputs the equalized time domain signal, the second signal input terminal inputs the hard decision signal, and the signal output terminal outputs the hard decision signal or the equalized time domain signal;

an error calculator having a first signal acquisition terminal, a second signal acquisition terminal and an error signal output terminal, wherein the first signal acquisition terminal inputs the equalized time domain signal, the second signal acquisition terminal inputs the hard decision signal, the error signal output terminal outputs an error signal, and the control signal input terminal inputs the error signal,

wherein the signal source is connected to the decision signal input terminal, the first signal input terminal and the first signal acquisition terminal respectively, and the decision result output terminal is connected to the second signal input terminal and the second signal acquisition terminal respectively, and the error signal output terminal is connected to the control signal input terminal; and

the condition decision device outputs the equalized time domain signal received by the first signal input terminal or outputs the hard decision signal received by the second signal input terminal according to the error signal received by the control signal input terminal.

A signal decision method comprising:

implementing a hard decision on a equalized time domain signal, outputting a hard decision signal and the equalized time domain signal;

outputting an error signal according to the hard decision signal and the equalized time domain signal;

implementing a condition decision on the equalized time domain signal and the error signal by using a pre-stored threshold condition, so as to output the hard decision signal or the equalized time domain signal.

Preferably, the equalized time domain signal includes an in-phase signal and a quadrature signal, so as to output a hard decision in-phase signal after implementing a hard decision on the in-phase signal and output a hard decision quadrature signal after implementing a hard decision on the quadrature signal; and

calculating a difference value between the hard decision in-phase signal and the in-phase signal, and a difference value between the hard decision quadrature signal and the quadrature signal, respectively.

Preferably, the signal decision method, wherein

implementing a hard decision on the in-phase signal and the quadrature signal simultaneously, and outputting the hard decision in-phase signal and the hard decision quadrature signal.

Preferably, the error signal is a difference value between the hard decision signal and the equalized time domain signal.

The beneficial effects of the above mentioned technical solution are:

By calculating an error for the hard decision signal, and then implementing a condition decision via the threshold condition, the technical solution decides to output the equalized time domain signal or the hard decision signal, and reduces the error of the output signal. The above technical solution improves the performance of the equalizer by implementing the iteratively update directly via the soft bit information of hard decision signal.

### BRIEF DESCRIPTIONS OF THE DRAWINGS

The accompanying drawings, together with the specification, illustrate exemplary embodiments of the present disclosure, and, together with the description, serve to explain the principles of the present invention.

FIGS. 1-2 are schematic structural views of an embodiment of a signal decision device according to the present invention;

FIG. 3 is a schematic diagram of an embodiment of a signal decision method according to the present invention;

FIG. 4 is a schematic structural view of an embodiment of an equalizer comprising a signal decision device according to the present invention.

### DETAILED DESCRIPTION

The present invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” or “has” and/or “having” when used herein, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the term “plurality” means a number greater than one.

Hereinafter, certain exemplary embodiments according to the present disclosure will be described with reference to the accompanying drawings.

It should be noted that, in the absence of conflict, the following technical solutions, technical characteristics can be combined with each other.

The present invention will be described in further detail with reference to the accompanying drawings.

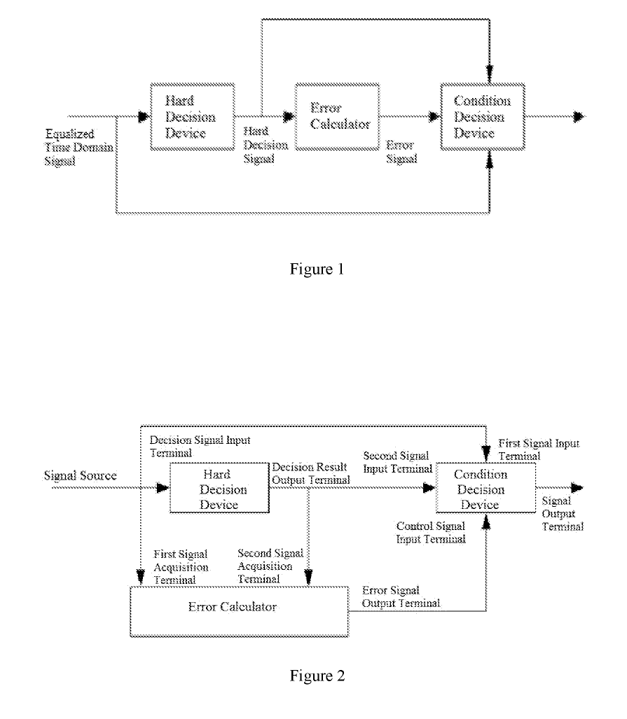

The embodiment provides a signal decision device, as shown in FIG. 1, comprising:

a signal source, configured to provide an equalized time domain signal;

a hard decision device, connected to the signal source, and configured to implement a hard decision on the equalized time domain signal so as to output a hard decision signal and the equalized time domain signal;

an error calculator, connected to the hard decision device, and configured to output an error signal according to the hard decision signal and the equalized time domain signal;

a condition decision device, connected to the error calculator and the hard decision device respectively, and configured to acquire the equalized time domain signal, the hard decision signal and the error signal, and to implement a condition decision on the equalized time domain signal and the error signal through a pre-stored threshold condition; and when the equalized time domain signal or error signal meets the threshold condition, the condition decision device outputs the hard decision signal, otherwise, the condition decision outputs the hard decision signal.

The present embodiment can be applied to generate the soft information bits of equalization signals such as QPSK, 16 QAM, 32 QAM, and 64 QAM. In the present embodiment, the condition decision device inputs three signals, which are an equalized time domain signal, a hard decision signal and an error signal respectively, in which the equalized time domain signal is the initial signal input by the hard decision device, the signal decided by the hard decision device is a hard decision signal. The hard decision criterion of the hard decision device in the present embodiment can be the hard decision criterion used in the prior art, and thus it is not described here. The error signal in the present embodiment is a signal after the hard decision signal and the equalized time domain signal is calculated by the error calculator.

In a preferred embodiment of the present invention, the equalized time domain signal includes an in-phase signal and a quadrature signal, the hard decision device outputs the hard decision in-phase signal after implementing the hard decision on the in-phase signal, and outputs the hard decision quadrature signal after implementing the hard decision on the quadrature signal.

In a preferred embodiment of the present invention, the hard decision device simultaneously implements a hard decision on the in-phase signal and the quadrature signal, so as to output the hard decision in-phase signal and the hard decision quadrature signal.

In a preferred embodiment of the present invention, the error signal is the difference value between the hard decision signal and the equalized time domain signal.

In a preferred embodiment of the present invention, the error calculator is further configured to calculate the difference value between the hard decision in-phase signal and the in-phase signal, and the difference value between the hard decision quadrature signal and the quadrature signal, respectively.

In the above-mentioned embodiment, the equalized time domain signal may include two signals, the in-phase signal and the quadrature signal. It should be noted that the hard decision device can simultaneously decide the two signals, the in-phase signal (I-way) and the quadrature signal (Q-way) signal. The hard decision device outputs the hard decision result of the two signals, namely the hard decision in-phase signal and the hard decision quadrature signal. The error calculator can calculate the error of the two signals respectively, for example, the error signal includes a first error signal which is a difference value between the hard decision in-phase signal and the in-phase signal, and a second error signal which is the difference value between the hard decision quadrature signal and the quadrature signal.

The conditional decision device may determine whether the first error signal meets the threshold condition and determine whether the second error signal meets the threshold condition. For example, for QPSK modulation, 4.5*0.75≤first error signal≤4.5, or equalized time field signal≤1.0 is conformity with the condition, that is, as long as one of the first error signal and the equalized time domain signal meets the condition, the hard decision in-phase signal can be output, otherwise the second error signal is output.

Likewise, for QPSK modulation, 4.5*0.75≤second error signal≤4.5, or equalized time field signal≤1.0 is conformity with the condition, that is, as long as one of the second error signal and the equalized time domain signal meets the decision condition, the hard decision in-phase signal can be output, otherwise the second error signal is output.

The present embodiment provides a signal decision, as shown in FIG. 2, comprising:

a signal source, configured to provide an equalized time domain signal,

a hard decision device comprising a decision signal input terminal and a decision result output terminal, wherein the decision signal input terminal inputs the equalized time domain signal, and the decision result output terminal outputs a hard decision signal,

a condition decision device, comprising a first signal input terminal, a second signal input terminal, a control signal input terminal and a signal output terminal, wherein the first signal input terminal inputs the equalized time domain signal, and the second signal input terminal inputs the hard decision signal, the signal output terminal outputs the hard decision signal or the equalized time domain signal;

an error calculator having a first signal acquisition terminal, a second signal acquisition terminal and an error signal output terminal, wherein the first signal acquisition terminal inputs the equalized time domain signal, the second signal acquisition terminal inputs the hard decision signal, the error signal output terminal outputs an error signal, and the control signal input terminal inputs the error signal,

wherein the signal source is connected to the decision signal input terminal, the first signal input terminal and the first signal acquisition terminal respectively, and the decision result output terminal is connected to the second signal input terminal and the second signal acquisition terminal respectively, and the error signal output terminal is connected to the control signal input terminal; and

the condition decision device outputs the equalized time domain signal received by the first signal input terminal or outputs the hard decision signal received by the second signal input terminal according to the error signal received by the control signal input terminal.

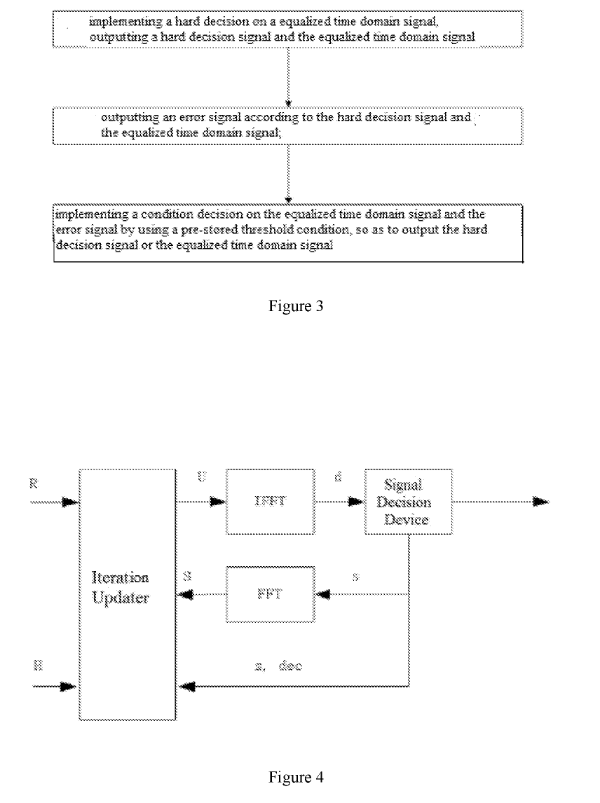

The present embodiment provides a signal decision method, as shown in FIG. 3, comprising:

Implementing a hard decision on the equalized time domain signal, outputting a hard decision signal and the equalized time domain signal;

Outputting an error signal according to the hard decision signal and the equalized time domain signal;

implementing a condition decision on the equalized time domain signal and the error signal by using a pre-stored threshold condition, so as to output the hard decision signal or the equalized time domain signal.

In a preferable embodiment of the invention, the equalized time domain signal includes an in-phase signal and an quadrature signal, so as to output a hard decision in-phase signal after implementing a hard decision on the in-phase signal and output a hard decision quadrature signal after implementing a hard decision on the quadrature signal; and

calculating the difference value between the hard decision in-phase signal and the in-phase signal, and the difference value between the hard decision quadrature signal and the quadrature signal, respectively.

In a preferable embodiment of the invention, the signal decision method, wherein,

implementing hard decision on the in-phase signal and the quadrature signal simultaneously, and outputting the hard decision in-phase signal and the hard decision quadrature signal.

In a preferable embodiment of the invention, the error signal is the difference value between the hard decision signal and the equalized time domain signal.

The present embodiment provides an equalizer, as shown in FIG. 4, which comprises the above-mentioned signal decision device using the signal decision method in the above-mentioned embodiment. The equalizer in the present embodiment includes an iteration updater, an inverse fast Fourier transformer, a fast Fourier transformer and the above-mentioned signal decision device. The equalizer can progressively improve the performance of the frequency domain equalizer by means of iterations. Based on the frequency domain value R of the input signal and the frequency domain value H of the channel of the input signal, after the initial iteration is implemented by using the iteration updater, the frequency domain value U of the iterated input signal can be transmitted to the IFFT (inverse fast Fourier transformer). The IFFT (inverse fast Fourier transformer) performs the inverse fast Fourier transform to obtain the equalized time domain signal d, and decides the value d output by the IFFT (inverse fast Fourier transformer) by using the signal decision device, and the signal decision device outputs signal s and s, dec, which are respectively transmitted to the FFT (fast Fourier transformer) and the iteration updater. That is, after calculating the FFT (fast Fourier transformer), the signal S also enters the iteration updater, then the iteration updater can start next iterations and equalization, and the progress above is repeated until the iteration termination condition is reached. In the above embodiment, the equalized time domain signal or the hard decision signal output from the signal decision device may be the s, dec signal in the present embodiment.

In summary, the above technical solution is implemented by a condition decision via the threshold condition, the technical solution decides to output the equalized time domain signal or the hard decision signal, and reduces the error of the output signal. The above technical solution improves the performance of the equalizer by implementing the iteratively update directly via the soft bit information of hard decision signal.

The foregoing is only the preferred embodiments of the invention, not thus limiting embodiments and scope of the invention, those skilled in the art should be able to realize that the schemes obtained from the content of specification and figures of the invention are within the scope of the invention.

What is claimed is:

1. A signal decision device, comprising:
a signal source, configured to provide an equalized time domain signal;
a hard decision device, connected to the signal source, and configured to implement a hard decision on the equalized time domain signal so as to output a hard decision signal and the equalized time domain signal;
an error calculator, connected to the hard decision device, and configured to output an error signal according to the hard decision signal and the equalized time domain signal;
a condition decision device, connected to the error calculator and the hard decision device respectively, and configured to acquire the equalized time domain signal, the hard decision signal and the error signal, and to implement a condition decision on the equalized time domain signal and the error signal through a pre-stored threshold condition, so as to output the hard decision signal or the equalized time domain signal.

2. The signal decision device according to claim 1, wherein the equalized time domain signal includes an in-phase signal and a quadrature signal, and the hard decision device outputs a hard decision in-phase signal after implementing a hard decision on the in-phase signal, and a hard decision quadrature signal after implementing a hard decision on the quadrature signal.

3. The signal decision device according to claim 2, wherein the hard decision device simultaneously implements a hard decision on the in-phase signal and the quadrature signal, so as to output the hard decision in-phase signal and the hard decision quadrature signal.

4. The signal decision device according to claim 1, wherein the error signal is a difference value between the hard decision signal and the equalized time domain signal.

5. The signal decision device according to claim 2, wherein the error calculator is further configured to calculate the difference value between the hard decision in-phase signal and the in-phase signal, and the difference value between the hard decision quadrature signal and the quadrature signal, respectively.

6. A signal decision device comprising:
a signal source, configured to provide an equalized time domain signal;
a hard decision device, comprising a decision signal input terminal and a decision result output terminal, wherein the decision signal input terminal inputs the equalized time domain signal, and the decision result output terminal outputs a hard decision signal;
a condition decision device, comprising a first signal input terminal, a second signal input terminal, a control signal input terminal and a signal output terminal, wherein the first signal input terminal inputs the equalized time domain signal, the second signal input terminal inputs the hard decision signal, and the signal output terminal outputs the hard decision signal or the equalized time domain signal;
an error calculator having a first signal acquisition terminal, a second signal acquisition terminal and an error signal output terminal, wherein the first signal acquisition terminal inputs the equalized time domain signal, the second signal acquisition terminal inputs the hard decision signal, the error signal output terminal outputs an error signal, and the control signal input terminal inputs the error signal;
wherein the signal source is connected to the decision signal input terminal, the first signal input terminal and the first signal acquisition terminal respectively, and the decision result output terminal is connected to the second signal input terminal and the second signal acquisition terminal respectively, and the error signal output terminal is connected to the control signal input terminal; and
the condition decision device outputs the equalized time domain signal received by the first signal input terminal or outputs the hard decision signal received by the second signal input terminal, according to the error signal received by the control signal input terminal.

7. A signal decision method, comprising:
implementing a hard decision on a equalized time domain signal, outputting a hard decision signal and the equalized time domain signal;
outputting an error signal according to the hard decision signal and the equalized time domain signal;
implementing a condition decision on the equalized time domain signal and the error signal by using a pre-stored threshold condition, so as to output the hard decision signal or the equalized time domain signal.

8. The signal decision method according to claim 7, wherein the equalized time domain signal includes an in-phase signal and a quadrature signal, so as to output a hard decision in-phase signal after implementing a hard decision on the in-phase signal and output a hard decision quadrature signal after implementing a hard decision on the quadrature signal; and
calculating a difference value between the hard decision in-phase signal and the in-phase signal, and a difference value between the hard decision quadrature signal and the quadrature signal respectively.

9. The signal decision method according to claim 8, wherein, implementing hard decision on the in-phase signal and the quadrature signal simultaneously, and outputting the hard decision in-phase signal and the hard decision quadrature signal.

10. The signal decision method according to claim 7, wherein the error signal is a difference value between the hard decision signal and the equalized time domain signal.
